(19) United States
(12) Patent Application Publication
(10) Pub. No.: US 2025/0314014 A1
(43) Pub. Date: Oct. 9, 2025

(54) METHOD FOR MANUFACTURING POROUS-STRETCHABLE FILM USING WET FILTER PAPER

(71) Applicant: Electronics and Telecommunications Research Institute, Daejeon (KR)

(72) Inventors: Sujung KIM, Daejeon (KR); Chan Woo PARK, Daejeon (KR); Seong Hyun KIM, Daejeon (KR); JAE JOON KIM, Daejeon (KR); Bock Soon NA, Daejeon (KR); Su Jae LEE, Daejeon (KR)

(21) Appl. No.: 18/884,045

(22) Filed: Sep. 12, 2024

(30) Foreign Application Priority Data
Apr. 5, 2024 (KR) 10-2024-0046705

(51) Int. Cl. D21H 19/14; D21H 27/00

(52) U.S. Cl. CPC D21H 19/14; D21H 27/00

(57) ABSTRACT

Provided is a method for manufacturing a porous-stretchable film. The manufacturing method includes providing an elastomer mixed solution on a filter paper, rotating the filter paper to coat the elastomer mixed solution, and providing water vapor to the filter paper and the elastomer mixed solution to form a porous-stretchable film.

### CROSS-REFERENCE TO RELATED APPLICATIONS

This U.S. non-provisional patent application claims priority under 35 U.S.C. § 119 of Korean Patent Application No. 10-2024-0046705, filed on Apr. 5, 2024, the entire contents of which are hereby incorporated by reference.

### BACKGROUND

The present disclosure herein relates to a method for manufacturing a porous-stretchable film, and more particularly, to a method for manufacturing a porous-stretchable film used in an electronic patch device.

Recently, as the demand for wearable healthcare devices for constant monitoring of vital signs for personal health monitoring, rehabilitation treatment, and the like has increased, research on wearable electronic patch devices has been actively conducted. An electronic patch device has a limitation in that the performance thereof is degraded when a person moves a body part or the skin produces sweat and oil. In order to overcome the limitation, patches with high flexibility and stretchability while having excellent adhesion and air permeability are required. In the case of a typical patch manufacturing technology, attempts have been made to develop a patch by generating microholes by using a mold produced by using lithography, 3D printing, or the like to give air permeability to the patch, or providing a microstructure similar to that of octopus suckers and the like on the surface of a patch to be attached to impart high adhesion to the patch, but such methods have limitations of having a complex manufacturing process.

### SUMMARY

The present disclosure provides a method for manufacturing a porous-stretchable film, the method capable of forming a porous-stretchable film having a simple manufacturing process and excellent air permeability.

An embodiment of the inventive concept provides a method for manufacturing a porous-stretchable film. The manufacturing method includes providing an elastomer mixed solution on a filter paper, rotating the filter paper to coat the elastomer mixed solution, and providing water vapor to the filter paper and the elastomer mixed solution to form a porous-stretchable film.

In an embodiment, the filter paper may include wet filter paper wet with first deionized water.

In an embodiment, the elastomer mixed solution may include Ecoflex and a curing agent.

In an embodiment, the Ecoflex and the curing agent may have a weight mixing ratio of 1:1.

In an embodiment, the elastomer mixed solution may further include a silicone adhesive.

In an embodiment, the Ecoflex, the curing agent, and the silicone adhesive may have a weight ratio of 1:1:2.

In an embodiment, the water vapor may be pumped under vacuum pressure.

In an embodiment, the water vapor may be heated to 120° C. or higher.

In an embodiment, the porous-stretchable film may have micropores, wherein the micropores may have a diameter of approximately 40 μm to approximately 200 μm.

In an embodiment, the filter paper may be rotated for 30 seconds at a speed of 1000 rpm.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a flowchart showing a method for manufacturing a porous-stretchable film according to the inventive concept;

FIG. 2A to FIG. 2F are process diagrams of a porous-stretchable film of the present invention;

FIG. 3 is a diagram showing an example of wet filter paper coated with an elastomer according to FIG. 2A to FIG. 2C;

FIG. 4 is a process conceptual diagram of FIG. 2E;

FIG. 5 and FIG. 6 are respectively optical microscope images and an electron microscope image showing an example of the porous-stretchable film of FIG. 4;

FIG. 7 is a flowchart showing a method for manufacturing an electronic patch device using the porous-stretchable film of FIG. 2F;

FIG. 8A to FIG. 8E are process cross-sectional views of an electronic patch device; and

FIG. 9 are photographs showing an example of the electronic patch device of FIG. 8E.

### DETAILED DESCRIPTION

Hereinafter, preferred embodiments of the inventive concept will be described in detail with reference to the accompanying drawings. Advantages and features of the inventive concept and methods of accomplishing the same may be understood more readily by reference to the following detailed description of exemplary embodiments and the accompanying drawings. However, the inventive concept is not limited to the embodiments described herein, and may be embodied in other forms. Rather, the embodiments introduced herein are provided to ensure that the disclosed contents may be thorough and complete, and that the spirit of the inventive concept may be sufficiently conveyed to those skilled in the art, and the inventive concept is only defined by the scope of claims. The same reference numerals refer to like elements throughout the specification.

The terms used herein are for the purpose of describing embodiments and are not intended to be limiting of the present invention. In the present specification, singular forms include plural forms unless the context clearly indicates otherwise. As used herein, the terms ‘comprises’ and/or ‘comprising’ are intended to be inclusive of the stated elements, operations and/or devices, and do not exclude the possibility of the presence or the addition of one or more other elements, operations, and/or devices. In addition, since the present specification is according to a preferred embodiment, reference numerals presented according to the order of description are not necessarily limited to the order.

In addition, embodiments described in the present specification will be described with reference to cross-sectional views and/or plan views which are ideal illustrations of the inventive concept. In the drawings, the thickness of films and regions are exaggerated for an effective description of technical contents. Accordingly, the shape of an exemplary drawing may be modified by manufacturing techniques and/or tolerances. Thus, the embodiments of the inventive concept are not limited to specific forms illustrated, but are intended to include changes in the form generated by a manufacturing process.

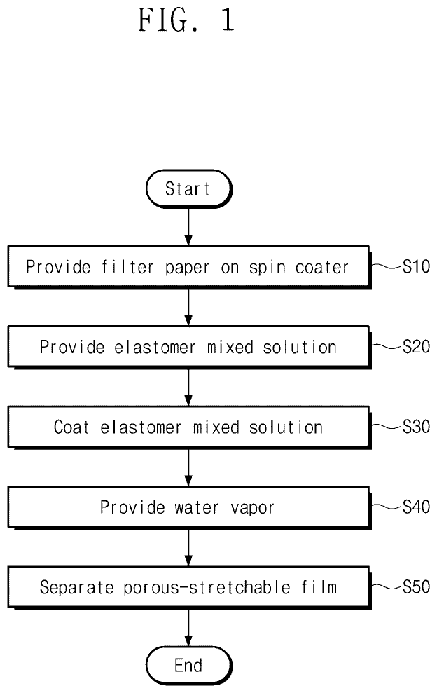

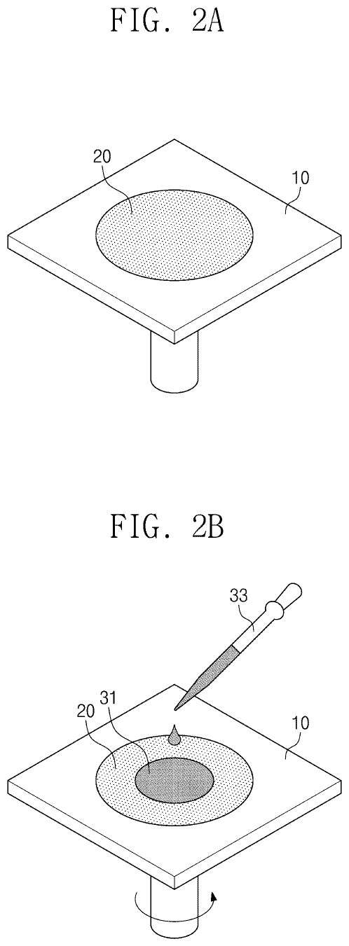

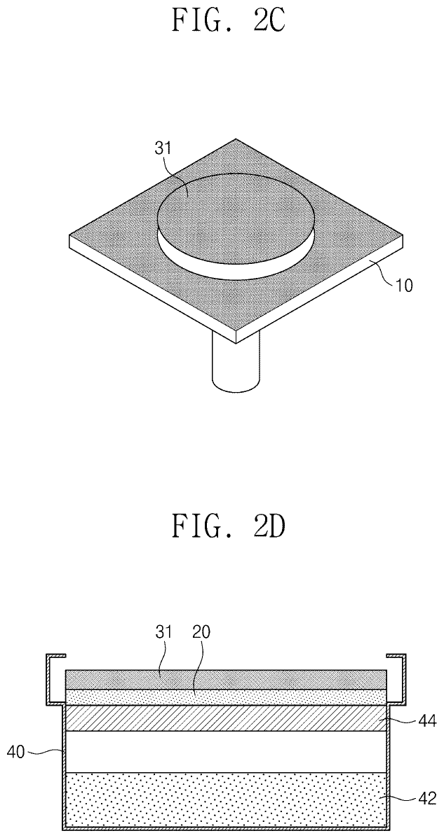

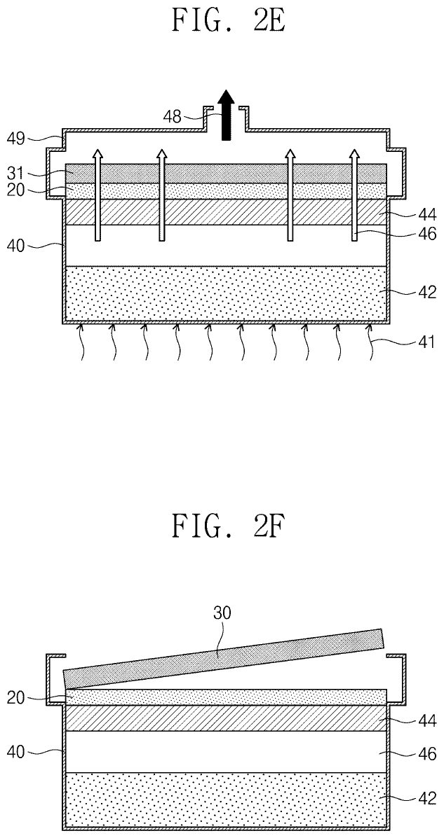

FIG. 1 shows a method for manufacturing a porous-stretchable film according to the inventive concept. FIG. 2A to FIG. 2G are process diagrams of a porous-stretchable film of the present invention.

Referring to FIG. 1 and FIG. 2A, wet filter paper 20 is provided on a spin coater 10 (S10). The wet filter paper 20 may be formed by the absorption of first deionized water, and the filter paper 20 may include hydrophilic filter paper, porous paper, or a porous polymer. More preferably, the filter paper 20 may be hydrophilic filter paper. Although not illustrated, the spin coater 10 may vacuum-adsorb the filter paper 20.

Referring to FIG. 1 and FIG. 2B, an elastomer mixed solution 31 is provided on the filter paper 20 adsorbed onto the spin coater 10 (S20). The elastomer mixed solution 31 may be a mixed solution of an elastomer and a curing agent, and may further include a silicone adhesive mixed solution to additionally add adhesive properties. The elastomer mixed solution 31 may contain polydimethylsiloxane (PDMS), Ecoflex, or silicone rubber. The silicone adhesive may include Silpuran, MG7-9960, or Ecoflex-gel. More preferably, the silicone adhesive may comprise an Ecoflex polymer, and the elastomer and curing agent may have a weight mixing ratio of about 1:1.

The elastomer mixed solution 31 should be in an uncured liquid state and may be coated on the filter paper 20 by means of a spin coater, a bar coater, or a doctor blade, wherein the coating may preferably be performed by using a spin coater. The elastomer mixed solution 31 may be provided on the filter paper 20 through a nozzle 33.

Referring to FIG. 1, FIG. 2B, and FIG. 2C, the spin coater 10 rotates the filter paper 20 to coat the elastomer mixed solution 31 on the filter paper 20 (S30). The thickness of an elastomer film on the filter paper 20 may be controlled by controlling the rotation speed of a spin coater to about 500 rpm to about 2000 rpm, and the elastomer film may have a thickness of about 100 nm to about 1 mm. Although not illustrated, the elastomer mixed solution 31 may be coated a plurality of times, and may be coated in a single layer or multiple layers by using one from each of the two groups of the elastomer and the silicone adhesive. As an example, after the coating of the elastomer mixed solution 31, by rotating the silicone adhesive mixed solution for about 30 seconds at a rotation speed of about 1000 rpm, thereby coating the same, it is possible to form a porous-stretchable film having a double-layered structure with a stretchable surface and an adhesive surface. More preferably, the silicone adhesive may comprise Ecoflex and an MG7-9960 adhesive.

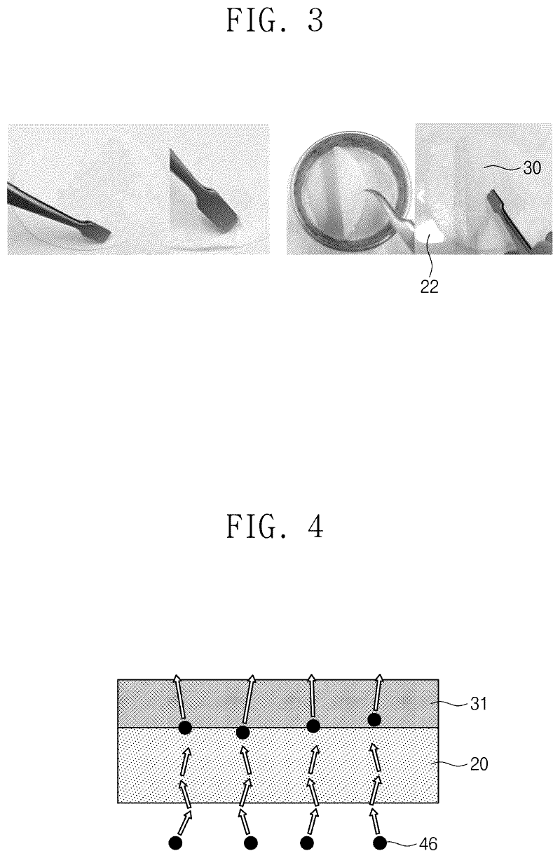

FIG. 3 shows an example of the wet filter paper 20 coated with an elastomer in accordance with FIG. 2A to FIG. 2C.

Referring to FIG. 3, it is possible to know the peeling properties of an elastomer film according to the moisture permeability of first deionized water on the filter paper. If an elastomer film is formed on dried filter paper 20, the film is attached to the surface of the filter paper, and thus, is not peeled off therefrom, but if an elastomer film is formed on wet filter paper 20, the film is detached from the surface of the filter paper, so that a porous-stretchable film in a free-standing form may be obtained.

Referring to FIG. 1, FIG. 2D, and FIG. 2E, water vapor 46 is provided to the filter paper 20 and the elastomer mixed solution 31 to form the porous-stretchable film 30 (S40). The wet filter paper 20 coated with the elastomer mixed solution 31 may be provided in a bath 40. The bath 40 may receive and/or store second deionized water 42 thereinside. A mesh 44 may be provided between the second deionized water 42 and the filter paper 20. The mesh 44 may be used as a handling substrate to support the filter paper 20 and elastomer mixed solution 31. The bath 40 may use external heat 41 to generate the water vapor 46 of the second deionized water 42. As an example, the second deionized water 42 may be heated to a temperature of 100° C. or higher to generate high-temperature water vapor. The water vapor 46 may be pumped and/or vented under vacuum pressure 48 through a lid 49 of the bath 40, and the vented water vapor may be removed by a cold trap between the lid 49 of the bath 40 and a vacuum pump. Although not illustrated, the water vapor 46 may be mixed or diluted with a nitrogen gas or an argon gas. The embodiment of the inventive concept is not limited thereto.

FIG. 4 is a process conceptual diagram of FIG. 2E.

Referring to FIG. 4, the water vapor 46 may penetrate and cure the filter paper 20 and the elastomer mixed solution 31 to form the porous-stretchable film 30. Here, the water vapor 46 may regenerate moisture in the filter paper 20 to maintain wetting, and may vaporize the first deionized water (22 of FIG. 3) to penetrate and cure the elastomer mixed solution 31 to form the porous-stretchable film 30.

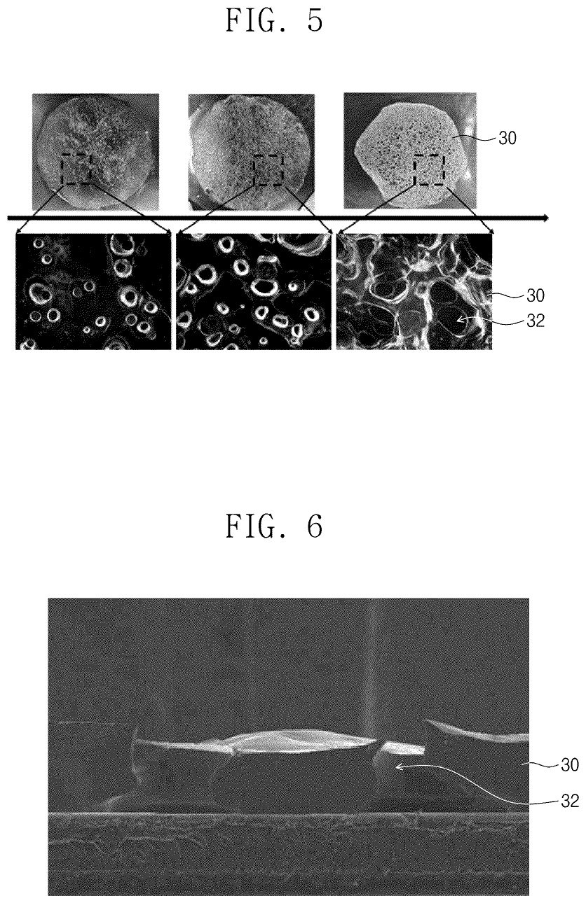

FIG. 5 and FIG. 6 show an example of the porous-stretchable film 30 of FIG. 4.

Referring to FIG. 4 to FIG. 6, the water vapor 46 may form a via-air hole or micropores 32 of the porous-stretchable film 30. Micropores 32 may have a diameter or size of about 40 μm to about 200 μm.

Referring to FIG. 5, the diameter or size of the micropores 32 of the porous-stretchable film 30 may increase in proportion to the vacuum pressure. The amount of generated water vapor changes according to the change in the boiling point of the second deionized water caused by the vacuum pressure, and the diameter and size of the pores may change depending on the amount of high-temperature water vapor penetrating the elastomer mixed solution. As an example, the vacuum pressure 48 may be about 0.03 MPa to about 0.07 MPa, and may be provided for about 1 minute to about 10 minutes. The vacuum pressure and the time are described based on an Ecoflex polymer, and are not necessarily limited thereto, and the pressure conditions may vary depending on the type and performance of a bath and a vacuum device.

Referring to FIG. 6, the micropores 32 may include the via-air hole extending from a lower surface to an upper surface of the porous-stretchable film 30.

Referring back to FIG. 1 and FIG. 2F, the porous-stretchable film 30 is separated from the filter paper 20 (S50). Referring back to FIG. 3, the porous-stretchable film 30 may be peeled off from the wet filter paper 20 without external force and be obtained in a free-standing form.

Therefore, the method for manufacturing the porous-stretchable film 30 of the present invention provides the high-temperature water vapor 46 to the elastomer mixed solution 31 on the filter paper 20, and thus, may form the porous-stretchable film 30 having a simple manufacturing process and excellent air permeability.

A method for manufacturing a wearable device using the above-described porous-stretchable film 30 is described as follows.

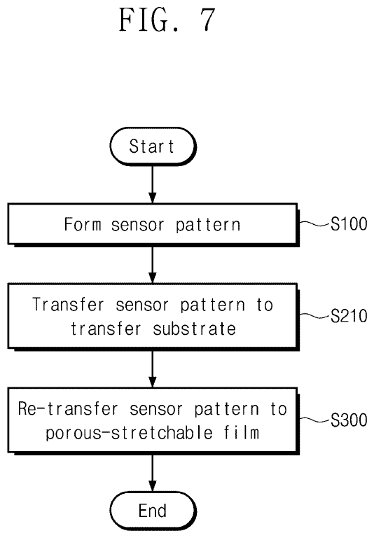

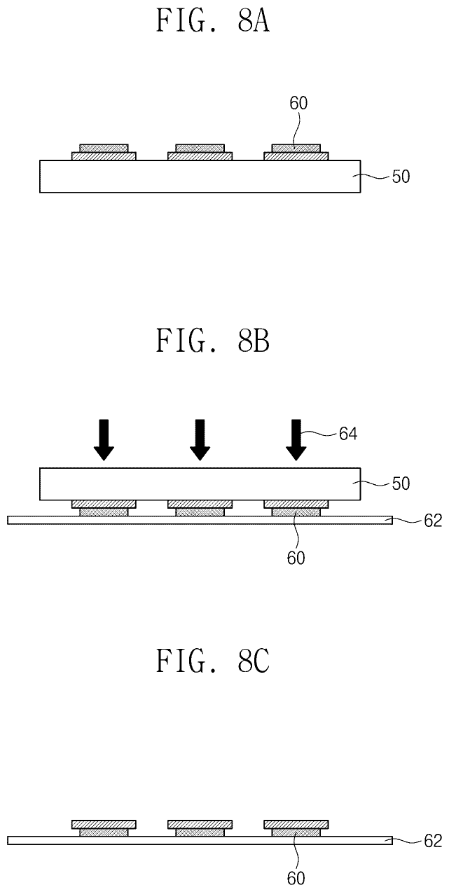

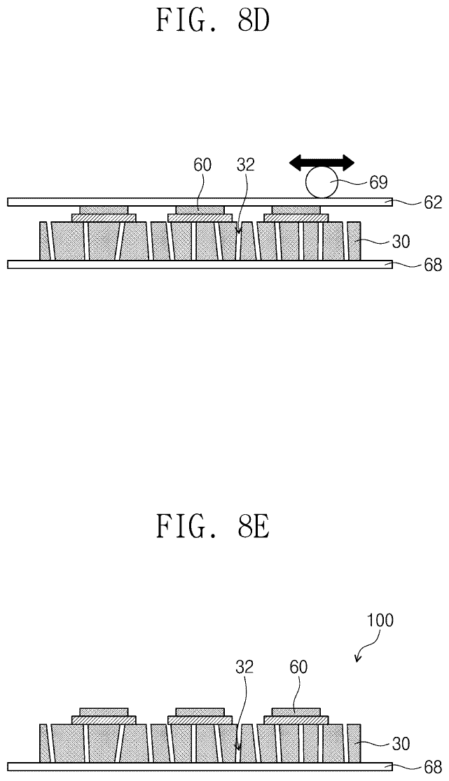

FIG. 7 shows a method for manufacturing an electronic patch device using the porous-stretchable film 30 according to one example of FIG. 2F. FIG. 8A to FIG. 8E are process cross-sectional views of an electronic patch device 100.

Referring to FIG. 7 and FIG. 8A, a sensor pattern 60 is formed on a device substrate 50 (S100). The device substrate 50 may include a glass substrate. The sensor pattern 60 may include a temperature sensor device, a vibration sensor device, a blood glucose sensor device, or a probe electrode device, but the embodiment of the inventive concept is not limited thereto.

Referring to FIG. 7, FIG. 8B, and FIG. 8C, the sensor pattern 60 is transferred to a transition substrate 62 (S200). The sensor pattern 60 may be transferred to the transition substrate 62 by a laser lift-off method. If the transition substrate 62 is attached onto the sensor pattern 60 of the device substrate 50, and a laser beam 64 penetrates the device substrate 50 and is provided to the sensor pattern 60, the sensor pattern 60 is melted by the laser beam 64 and separated from the device substrate 50, and may be transferred to the transition substrate 62.

Referring to FIG. 7, FIG. 8D, and FIG. 8E, the sensor pattern 60 is re-transferred to the porous-stretchable film 30 (S300). The sensor pattern 60 may be re-transferred to the porous-stretchable film 30 by a pressing process. The pressing process of the sensor pattern 60 may be performed by a roller 69. The porous-stretchable film 30 may be provided on a pick-up substrate 68. The sensor pattern 60 may be provided on the porous-stretchable film 30. The transition substrate 62 may be provided on the sensor pattern 60. The roller 69 may press the transition substrate 62 and the sensor pattern 60 to the porous-stretchable film 30. The sensor pattern 60 may be bonded to the porous-stretchable film 30. Thereafter, the transition substrate 62 is removed, so that the manufacturing process of the electronic patch device 100 may be completed.

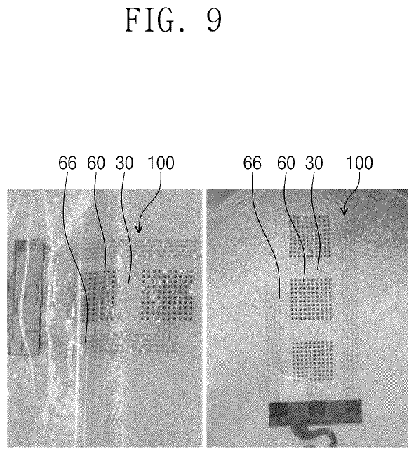

FIG. 9 shows an example of the electronic patch device 100 of FIG. 8E.

Referring to FIG. 9, the sensor pattern 60 of the electronic patch device 100 may be disposed in an array form on the porous-stretchable film 30. The sensor pattern 60 may be connected to an external terminal via a wire 66.

As described above, a method for manufacturing a porous-stretchable film according to an embodiment of the inventive concept provides high-temperature water vapor to an elastomer mixed solution on wet filter paper to form a porous-stretchable film having a simple manufacturing process and excellent air permeability.

Although the embodiments of the present invention have been described with reference to the accompanying drawings, those skilled in the art will understand that the present invention can be implemented in other specific forms without changing the technical spirit or essential features thereof. Therefore, the embodiments described above should be understood as illustrative in all respects and not restrictive.

What is claimed is:

1. A method for manufacturing a porous-stretchable film, the method comprising:
providing an elastomer mixed solution on a filter paper;
rotating the filter paper to coat the elastomer mixed solution; and
providing water vapor to the filter paper and the elastomer mixed solution to form a porous-stretchable film.

2. The method of claim 1, wherein the filter paper comprises wet filter paper wet with first deionized water.

3. The method of claim 1, wherein the elastomer mixed solution comprises Ecoflex and a curing agent.

4. The method of claim 3, wherein the Ecoflex and the curing agent have a weight mixing ratio of 1:1.

5. The method of claim 4, wherein the elastomer mixed solution further comprises a silicone adhesive.

6. The method of claim 5, wherein the Ecoflex, the curing agent, and the silicone adhesive have a weight ratio of 1:1:2.

7. The method of claim 1, wherein the water vapor is pumped under vacuum pressure.

8. The method of claim 1, wherein the water vapor is heated to 120° C. or higher.

9. The method of claim 8, wherein the porous-stretchable film has micropores, wherein the micropores have a diameter of approximately 40 μm to approximately 200 μm.

10. The method of claim 9, wherein the filter paper is rotated for 30 seconds at a speed of 1000 rpm.
